(19) United States
(12) Patent Application Publication
(10) Pub. No.: US 2011/0255314 A1
(43) Pub. Date: Oct. 20, 2011

(54) SWITCHED POWER CONVERTER WITH EXTENDED HOLD-UP TIME

(75) Inventors: Johann Baptist Daniel Kuebrich, Schlusselfeld (DE); Thomas Antonius Duerbaum, Baiersdorf (DE); Marcus Schmid, Jettingen-Scheppach (DE); Hans Halberstadt, Groesbeek (NL)

(73) Assignee: NXP B.V., Eindhoven (NL)

(21) Appl. No.: 13/142,261

(22) PCT Filed: Dec. 21, 2009
(86) PCT No.: PCT/IB2009/055888

§ 371 Date: Jun. 24, 2011

(30) Foreign Application Priority Data
Dec. 31, 2008 (EP) 08106042.8

(51) Int. Cl. H02M 7/155; H02M 1/42

(52) U.S. Cl. 363/46

(57) ABSTRACT

A power supply module having a PFC stage has a hold-up capacitor (34) for continuing output power for a time after an ac power supply (2) stops. The hold-up capacitor is charged by a winding (40) driven magnetically from a first winding (24); the first winding (24) may be the winding used in a boost converter stage, such as commonly used in a PFC stage, or alternatively the winding in an alternative stage such as a flyback converter.

The invention relates to a power supply, especially a switching power supply, with an extended hold-up and a method of operation of the power supply.

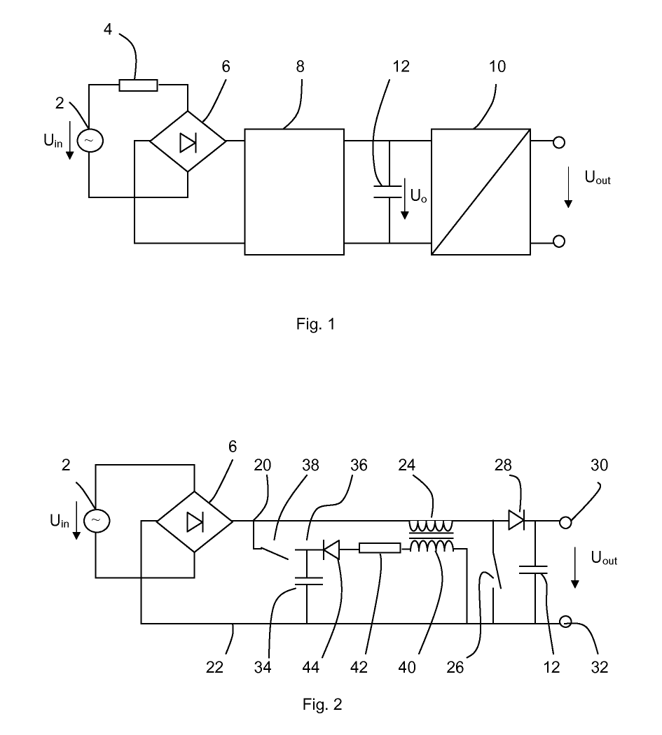

FIG. 1 illustrates very schematically a switching power supply. An input ac source 2 is connected through inrush resistor 4 to rectifier 6 which generates a rectified voltage. This is in turn supplied to a power factor correction (PFC) stage 8 which is typically a boost converter. The output of the boost converter 8 is typically a higher voltage than the peak input voltage supplied by the rectifier 6. The output of the boost converter 8 is converted to the required output voltage by a dc-dc switching module 10 which provides one or more dc output voltages.

A capacitor 12 is provided on the output of the PFC stage 8 which has a number of functions. The first function of the capacitor 12 is to reduce the ripple voltage on the output of the PFC stage 8. The ripple voltage is caused by the ac input power on rectifier 6 which produces a 100 Hz ripple on the output of the PFC stage. The capacitor 12 acts as a smoothing capacitor to smooth out the ripple voltage.

Of course, the ripple voltage is produced in turn by a ripple current and so the smoothing capacitor 12 needs to be large enough to conduct the ripple current. Accordingly, the need to carry the ripple current also imposes a minimum requirement on capacitor 12. Moreover, capacitor 12 is usually implemented as an electrolytic capacitor to deliver specific capacitance, and in such electrolytic capacitors the permissible ripple current is a function of frequency. Both the PFC stage 8 and the switching module 10 use high frequency switching which impose significant stress to the capacitor, requiring a minimum capacitance for capacitor 12.

A third factor which is often most important in determining the required size of capacitor 12 is the need for the capacitor 12 to cope with the system's hold-up requirements. In order to assure correct operation of switching module 10, the output voltage of the PFC stage 8 across capacitor 12 needs to be maintained above a minimum value for a short period even after the complete loss of input ac line voltage. To achieve a long hold-up time requires a large capacitor 12.

However, the use of a large capacitor 12 brings with it several problems. Firstly, the dimensions of the capacitor, both in terms of circuit board area and volume can be inconveniently large. Secondly, the use of an electrolytic capacitor often results in limited lifetimes especially as the capacitor is under stress from the ripple and switching currents. Thirdly, the large value of the capacitor 12 brings with it a high inrush current when the device is switched on and the capacitor 12 is charged up. As well as needing a capacitor 12 capable of dealing with the inrush current, the inrush current also stresses other components. Although the inrush current can be reduced with inrush resistor 4, such a resistor drops voltage and causes losses even under normal operation.

It would therefore be beneficial to reduce the required capacitance in a switching power supply.

A proposal has been made for a circuit using two capacitors in EP 0945 968. In this case, a hold-up capacitor is charged from the output capacitor through a limiting resistor.

According to the invention there is provided a circuit according to claim 1:

By charging the hold-up capacitor through winding an additional winding on the magnetic component the energy storage of the capacitor can be optimally utilized. The use of a winding allows the turn ratio of the first winding and the second winding to be selected to generate an optimized voltage across the hold-up capacitor. The hold-up capacitor can accordingly be selected on the basis of maximum energy storage, or maximum energy storage for a given price, and/or on the basis of the best voltage to apply for driving the circuit during the “hold up” phase when the ac supply stops.

The hold-up capacitor has no direct path to the mains. Therefore it is not charged via an inrush current pulse. Secondary inrush can also be significantly reduced.

The hold-up capacitor 34 can be made small due to the optimum, adaptable choice of charging voltage. In particular, the charging voltage of the hold-up capacitor may be restricted to below the voltage at the output capacitor.

Since the hold-up capacitor 34 is not used permanently a cheaper and smaller capacitance can be used without adversely affecting the reliability of the converter.

For a better understanding of the invention, embodiments will now be described, purely by way of example, with reference to the accompanying drawings, in which:

FIG. 1 shows a prior art switching power module;

FIG. 2 shows a first embodiment of the invention;

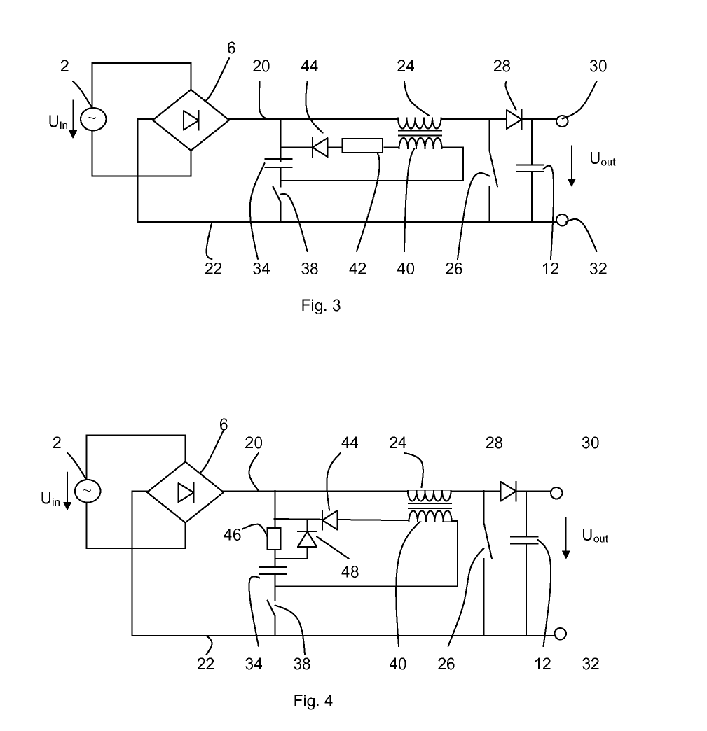

FIG. 3 shows a second embodiment of the invention;

FIG. 4 shows a third embodiment of the invention;

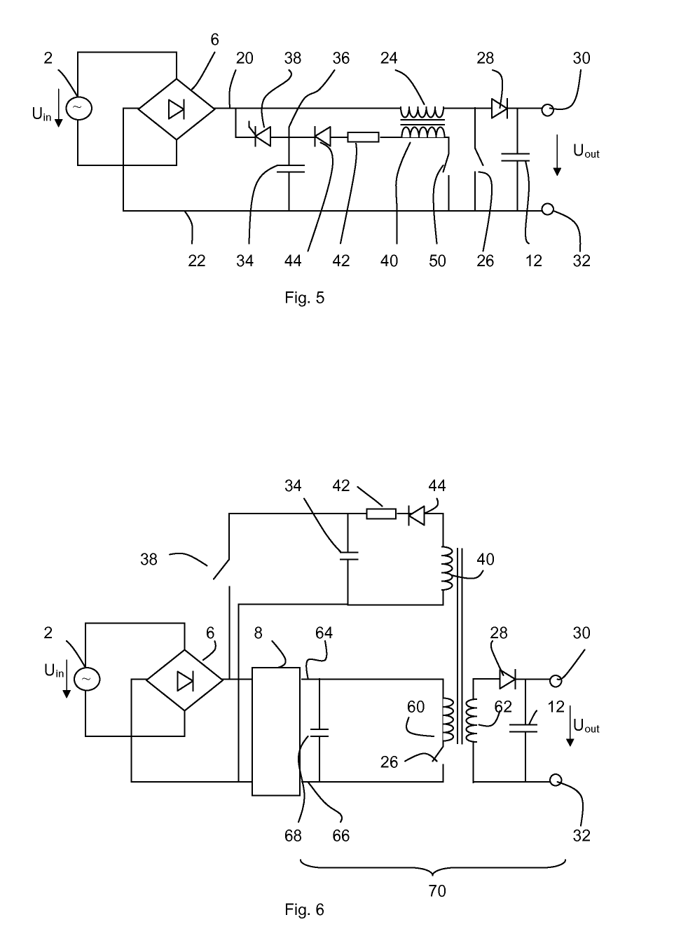

FIG. 5 shows a fourth embodiment of the invention; and

FIG. 6 shows a fifth embodiment of the invention.

The drawings are schematic and not to scale.

Referring to FIG. 2, an example embodiment of the invention has a modified PFC stage in the form of a boost converter.

An input ac source 2 is connected to full-wave rectifier 6 which outputs a rectified dc signal to high and low side dc lines 20,22. The high side dc line 20 is connected through a boost coil, i.e boost winding 24 and switch 26 to the low side dc line 22. A diode 28 connects the boost winding 24 to high side output terminal 30; low side output terminal 32 is connected to the low side dc line 22. An output capacitor 12 is provided across output terminals 30,32.

These components form a relatively conventional boost converter used as a PFC stage to increase the output voltage on output terminals 30, 32 by switching switch 26 under the control of a controller (not shown). The output voltage on output terminals 30,32 will be referred to as Uₒᵤₜ.

To provide additional hold-up, i.e. continued power when the ac input stops, a hold-up capacitor 34 is provided between the low side dc line 22 and a hold-up node 36 which is connected through hold-up switch 38 to the high side dc line 20. In the event of a power failure, hold-up switch 38 is closed to connect the hold-up capacitor 34 across the high and low side dc lines 20,22 to provide additional operating time.

To charge the hold-up capacitor a hold-up winding 40 is connected through charging current limiting resistor 42 and diode 44 across the capacitor 34. The hold-up winding 40 is magnetically coupled to boost winding 24 by being an additional winding on the same core as the boost winding 24.

There are Nₚ turns on the boost winding 24 (the primary) and Nₛ turns on the hold-up winding 40 (the secondary). The ratio (Nₛ/Nₚ) is known as the turns ratio. After several line cycles a voltage U_{c}=(Nₛ/Nₚ) Uₒᵤₜ will be achieved across the hold-up capacitor 34.

If the input voltage drops off, the hold-up switch 38 is closed and the stored energy on the hold-up capacitor 34 is used to maintain the boost operation of the circuit.

The circuit offers considerable advantages over the circuit of FIG. 1. Firstly, the output capacitor 12 is assisted in its hold-up task by the hold-up capacitor 34, so the output capacitor 12 only needs to be sufficiently large to reduce appropriately the ripple on the output voltage caused by the fluctuating input voltage. Normally, this allows a significantly smaller output capacitor 12 than in the FIG. 1 arrangement. This may even allow the output capacitor to be a film capacitor instead of an electrolytic capacitor—such film capacitors have a longer lifetime and are not affected by ripple currents. Moreover, the use of a smaller output capacitor 12 results in lower inrush currents and so it may be possible to avoid the use of inrush current limiters 4 (FIG. 1), though of course such limiters may be used if required.

By charging the hold-up capacitor 34 from a secondary winding on the same core, the voltage that the hold-up capacitor can be charged to can be arbitrarily selected simply by selecting a suitable turns ratio. This allows the hold-up capacitor to be selected optimally for the best stored energy for a given price. Moreover, a low cost capacitor with a higher equivalent series resistance (ESR) can be used.

Comparing the circuit with that proposed in EP 945 968, the key difference is that the hold-up capacitor is charged by a winding, not by a resistor in series with the output voltage. This permits the voltage on the capacitor to be selected optimally. In contrast, in EP 945 968, the hold-up capacitor is connected to the output terminals and so can only be charged to the same voltage as the output. Further, note that in EP 945 968 the hold-up capacitor is also connected to the output of the rectifier in the case of failure of input power, so in the case where power is being supplied by the hold-up capacitor the voltage at the input of the boost converter is the same as the output voltage.

A further disadvantage of the circuit proposed in EP 945 968 is that during normal operation the hold-up capacitor is connected to the output terminals, continuously charged through a resistor and discharged through a diode. This can lead to continuing losses in the resistor and diode and lower efficiency.

FIG. 3 illustrates an alternative arrangement. In this case, the hold-up switch 38 is a low-side switch connected between the low side of hold-up capacitor 34 and the low side dc line 22. The high side of the hold-up capacitor 34 is connected directly to the high side output terminal 20. In this way, the inner charging circuit is effectively floating and is only connected to ground by closing the low-side switch in case of loss of input ac power. The detection can be made using the input voltage Vin or the voltage across the capacitor C12.

The embodiments of FIGS. 2 and 3 both include charging current limiting resistor 42. FIG. 4 illustrates an alternative arrangement in which charging current limiting resistor 46 is provided between the hold-up capacitor 34 and high side dc line 20. A bypass diode 48 is used to bypass the limit resistor 46 during the hold-up period of operation when the hold-up capacitor 34 is maintaining the voltage on dc lines 20,22.

The function of this limit resistor 46 will now be explained. In view of the smaller size of output capacitor 12 compared with the FIG. 1 embodiment means that during normal operation the limiting resistor 4 (FIG. 1) may not be needed in view of the lower input inrush current.

However, in the event of ac line power returning after the hold-up switch 38 has been closed, a much larger capacitance formed by the hold-up capacitor 34 as well as output capacitor 12 will result in a large secondary inrush current in this case. In order to limit the inrush current, especially to the hold-up capacitor 34, the charging current limiting resistor 46 is provided between line 20 and the windinghold-up capacitor 34.

FIG. 5 illustrates another embodiment, a modification of the arrangement of FIG. 2, in which another approach is used to counter the secondary inrush current. In this embodiment, hold-up switch 38 is implemented using a thyristor. This has the advantage that the thyristor only conducts in a predefined direction, so energy flow from the hold-up capacitor 34 to the dc lines 20,22 is possible but direct charging of the hold-up capacitor when ac power is restored is not possible.

FIG. 5 also illustrates another modification, which may also be incorporated in the embodiments of FIGS. 2 to 4. In the FIG. 5 embodiment, an additional switch 50 is provided in the loop of hold-up capacitor 34 and hold-up winding 40.

This additional switch can be controlled to optimize the voltage and charging of the hold-up capacitor. In particular, the additional switch 50 allows the hold-up capacitor 34 to be charged to a different voltage to that determined by the output voltage and the turns ratio. This is of particular benefit where the output voltage may vary.

Although the circuit in FIG. 5 is a modification of FIG. 2, the circuit could also be a modification of FIG. 3 or 4. In particular, the thyristor could alternatively also be ground referenced.

The above embodiments all incorporate the hold-up capacitor in the PFC circuit. However, a similar approach may be used with the hold-up capacitor incorporated in a subsequent circuit, for example a secondary converter stage. FIG. 6 is an example of this type of circuit.

In this case, the PFC stage 8 is a conventional PFC stage which feeds a secondary converter stage 70, here a flyback converter, including first winding 60 magnetically coupled to output winding 62, which in turn is coupled by diode 28 to output terminals 30,32 with output capacitor 12 across the output terminals 30,32.

The first winding is connected in series with switch 26 across the high and low side dc lines 64, 66 of the PFC stage 8; a PFC output capacitor 68 is present across these dc lines.

The hold-up capacitor 34 is provided with one side connected to the low side input of the PFC stage and with its other side connected through hold-up switch 38 to the high side input to PFC stage 8. The location of the hold-up capacitor and the way it is charged through a winding ensures that it is not charged and discharged during a normal cycle of the fly-back stage. In an alternative embodiment the hold-up capacitor 34 is connected through hold-up switch 38 to the high side dc line 64 and directly to the low side dc line 66.

To charge the hold-up capacitor 34, hold-up winding 40 is connected through diode 44 and limit resistor 42 across the hold-up capacitor. The hold-up winding is formed of additional windings on the same core as first winding 60 and output winding 62.

In use, the circuit of hold-up winding 40, diode 44 and limit resistor 42 slowly charges the hold-up capacitor 34. As in the embodiments described above, the turns ratio Nₛ/Nₚ can be adjusted to select the voltage level of the hold-up capacitor 34 for optimal energy storage. Accordingly, this embodiment, like the embodiments above, allow the original output capacitor 12 to be reduced in size since it is no longer providing a hold-up function, only reducing ripple voltage. Its size and value is otherwise only determined by the rms current. If capacitors using an alternative technology are used, such as film capacitors, the maximum allowed output voltage ripple will determine the necessary capacitance value.

Note in particular that using this circuit the voltage on hold-up capacitor 34 can be adapted, by selecting a suitable turns ratio, to minimise hold-up current when hold-up switch 38 is closed.

Similar alternatives to those discussed above with reference to the FIG. 2 embodiment in FIGS. 3, 4 and 5 can be implemented also with the circuit of FIG. 6. For example, the switch 38 of FIG. 6 may be replaced with a low-side switch between the hold-up capacitor 34 and the low side input of the PFC or the low side dc line 66, in a similar way to the embodiment discussed above with reference to FIG. 3. A resistor and diode combination may be used to limit inrush current when ac power is restored with switch 38 closed, in a similar way to the embodiment discussed above with respect to FIG. 4. Alternatively, the switch 38 may be implemented by a thyristor, in a similar manner to FIG. 5.

Those skilled in the art will realise that the invention can be implemented in many alternative ways. For example, FIG. 6 shows a particular implementation of a circuit using a flyback converter but other circuits may also be used, such as a LLC resonant converter, or indeed any circuit with a winding to which an additional winding can be added to charge the hold-up capacitor.

The secondary converter stage may be, for example, an additional standby converter stage.

The invention can be used in any application using power factor correction circuitry. Applications accordingly include adaptors for information technology power supply, such as laptops, faxes, printers, desktop printers, as well as consumer adaptors, dvd players, mobile telephone chargers and the like.

1. A switching power supply module, comprising
high and low side output terminals;
an output capacitor across the output terminals;
high and low side dc lines;
a first winding and a first switch arranged to switch power from the dc lines through the first winding to deliver power to the output terminals;
a hold-up capacitor for supplying hold-up power to the dc lines;
wherein
a second winding is coupled to the first winding, the second winding being connected across the hold-up capacitor for charging the hold-up capacitor.

2. A switching power supply module according to claim 1 wherein the first winding is an inductor in a power factor correction stage and the second winding is a separate winding on the core of the first winding.

3. A switching power supply module according to claim 1 wherein the first winding, first switch, and output terminals are configured as a boost converter and the second winding is an additional winding on the same core as the first winding.

4. A switching power supply module according to claim 1 having a power factor correction stage and a secondary converter stage, wherein the first winding is an inductor in the secondary converter stage and the second winding is a separate winding on the core of the first winding.

5. A switching power supply module according to claim 1 wherein the first winding is a first winding of a flyback converter magnetically coupled to an output winding connected to the high and low side output terminals and the output capacitor, wherein the second winding is an additional winding on the same core as the first winding.

6. A switching power supply module according to claim 1;
wherein the hold-up capacitor is connected between the dc lines in series with a hold-up switch; and
the second winding is connected across the hold-up capacitor through a diode.

7. A switching power supply module according to claim 6 wherein the hold-up switch is a low-side switch connected between the hold-up capacitor and the low side dc line.

8. A switching power supply module according to claim 6 further comprising a current limiting element in series between the second winding and the hold-up capacitor.

9. A switching power supply module according to claim 8 further comprising a diode in parallel with the current limiting element.

10. A switching power supply module according to claim 6 wherein the hold-up switch is a thyristor.

11. A switching power supply module according to claim 1 further comprising a full-wave rectifier connected to the dc lines for rectifying ac power.

12. A switching power supply module according to claim 11 further comprising a power factor correction stage on the output of the full-wave rectifier, the dc lines being the output of the power factor correction stage.
